(19) United States
(12) Patent Application Publication
(10) Pub. No.: US 2026/0067090 A1
(43) Pub. Date: Mar. 5, 2026

(54) SYSTEM, METHOD, AND COMPUTER PROGRAM PRODUCT FOR SECURE COMMUNICATION BETWEEN TWO ACTORS

(71) Applicant: KAPRION TECHNOLOGIES GMBH, Dresden (DE)

(72) Inventors: André RÖDER, Dresden (DE); Klaus RÖDER, Dresden (DE); Tobias EHRLICH, Dresden (DE)

(73) Assignee: KAPRION TECHNOLOGIES GMBH, Dresden (DE)

(21) Appl. No.: 19/317,693

(22) Filed: Sep. 3, 2025

(30) Foreign Application Priority Data
Sep. 3, 2024 (EP) 24198236

(51) Int. Cl. H04L 9/32; H04L 9/08; H04L 9/30

(52) U.S. Cl. CPC H04L 9/3234; H04L 9/0825; H04L 9/3073

(57) ABSTRACT

The invention relates to a system comprising at least one ID wallet (software for managing digital identities and verifiable digital credentials) and at least one hardware security module (HSM) for the secure, authenticated exchange of digital credentials between two actors of a common digital identity ecosystem, as well as to a method and to a computer program product for secure, authenticated communication between two such systems for issuing, transmitting and receiving digital credentials and providing and verifying proof of ownership thereof.

### CROSS REFERENCE TO RELATED APPLICATIONS

This application claims priority to European Patent Application No. 24 198 236.2, filed on Sep. 3, 2024, the entire contents of which are hereby incorporated by reference herein.

### FIELD OF THE INVENTION

The invention relates to a system comprising at least one ID-wallet (digital identity wallets) and at least one hardware security module (HSM) for the secure exchange of digital credentials between two actors of a common digital ID ecosystem, as well as to a method and to a computer program product for secure communication between two such systems for managing digital credentials.

### BACKGROUND OF THE INVENTION

Due to the global increase in average age and thus the non-working proportion of the total population, the need for automation and the associated digitization is increasing in almost all areas of the economy and society, including the fields of administration and government and intergovernmental authorities.

Digitizing administration requires secure digital identities that cannot be copied. Digital identities are data stored in computer systems that relate to individuals, organizations, applications, or devices. For individuals, they may include the personal data necessary to confirm their individual identity and to manage interactions between different parties through digital systems.

Furthermore, procedures are required to enable the issuance, secure verification, transfer and management of digital credentials in general and to ensure that they cannot be copied at will.

Methods for managing digital identities and digital credentials are known in the prior art.

An ID wallet is a software for managing verifiable digital credentials in combination with a memory area allocated to and managed by the software and intended for storing digital credentials on the hardware on which the software runs. A verifiable digital credential is a digital credential that is provided by its issuer with information that allows a verifier to verify certain attributes of a digital credential. The identity of the issuer can then be verified using the issuer's digital signature, which comprises a digital credential. The authenticity of the digital credential can be verified using a cryptographic hash (a cryptographic hash value) comprising a digital credential. Furthermore, a digital credential can be provided with an identifier of the holder, which allows a verifier to determine to whom the credential was issued.

By comparing it with various central and/or decentralized trust registries, further attributes of the credential can be verified using an ID wallet.

By comparing it with a validity registry, an ID wallet of a verifier can check whether a digital credential is valid. A registry for verifiable credential schemes allows the verifier's ID wallet to determine whether the digital credential scheme is correct. The verifier's ID wallet can check whether an issuer was authorized to issue a digital credential by comparing it with an issuer registry. Furthermore, the verifier's ID wallet can verify whether the ID wallet meets the requirements of the ID ecosystem by comparing it with an ID wallets registry. By a comparison with a decentralized identifiers registry (DID registry), the verifier's ID wallet can check whether the ID wallet holder is known to the verifier. Using a verifiers registry, a holder of a digital credential can check whether a verifier is authorized to submit a verification request.

ID wallets currently available on the market do not allow all the verifications mentioned in the previous paragraph to be performed using a trust registry.

A self-sovereign identity (SSI) is a digital identity that an actor can create and manage for itself. In contrast to other types of digital identities, no additional authority is required to create and issue the digital identity. Thus, the actor has control over which data contained in their digital identity they transmit to whom and under what conditions. An actor with a digital identity is identifiable to other actors within a digital ID ecosystem by a cryptographically generated digital identifier (DID). A first actor can sign a digital credential that they issue to a second actor using an asymmetric key associated with their DID. The DID of the second actor is included in the signature when the credential is issued. When presenting the digital credential to a third actor, the second actor can be identified to the third actor using the second actor's DID. Since the signature of the digital credential contains the first actor's DID, the third actor can verify that the first actor issued the digital credential. Since the signature of the digital credential also includes the second actor's DID, the third actor can verify that the second actor is authorized to present the digital credential.

On cryptographic keys that are not stored in a memory dedicated solely to cryptographic keys, but in a memory in which other data and/or software of a digital terminal are also stored, the operating system at least can access the cryptographic key. This would make such keys copyable. Data stored in this way is also called “stored in software”.

Hardware security modules (HSMs), also known as hardware secure modules, are computing devices that enable the storage and management of cryptographic keys and the performance of cryptographic calculations. This allows data to be encrypted and decrypted without additional software. They are designed to detect physical attacks aimed at reading memory content and deleting it, do not emit signals indicating the data processed therein, and only output the data stored therein (program code, cryptographic keys, other parameters) dedicatedly to cryptographically authorized components via defined interfaces. This protects the cryptographic keys and the data encrypted therewith from being accessed by attackers. For example, they can be integrated into a USB stick and thus connected to the USB port of a terminal, or integrated into a chip card and connected to a terminal using a card reader.

HSMs are used for two-factor authentication using a challenge-response method based on public key authentication to prove authorization to access online services in addition to an additional factor. Such an additional factor could be, for example, an access password or a digital personal document.

The application principle is as follows: actor B has the key pair b, consisting of the private key and public key. B gives the public key to actor A in order to be identified thereby. However, the private keys are stored in software, which is why they can in principle be copied.

The principle is therefore not applicable to SSI-based identity management, since digital identities can exist plurally due to the lack of effective copy protection.

With federated identity management known in the art, it is possible to store attributes of an identity (also known as identity markers) on an HSM. Using federated identity management, an actor having an identity can be authenticated to different cooperating actors (such as different cooperating web service providers or cooperating authorities of different states), wherein each of these cooperating actors either trusts a central authentication authority or trusts each authentication authority of the other cooperating actors.

Federated identity management is therefore not applicable for SSI-based identity management either, because secure communication is only possible via an authentication authority and self-determined sharing of data by the holder of an identity using their digital terminal is not possible.

According to the prior art, implicit methods for data transmission are used in connection with HSMs. This means that the knowledge required to interpret the data must be available to the recipient. In chip-card-based applications, such as the electronic proof of identity of the Federal Republic of Germany (eID), the attributes of the holder's identity are stored in the chip card, such as an identity card with eID function. These attributes are stored, for example, in tag-length-value (TLV) formats, also known as type-length-value formats. When using TLV formats, senders and receivers must exchange the knowledge required to interpret transmitted data, which hinders interoperability.

To implement SSI, according to the prior art, self-describing data formats such as the JSON format are used to represent digital credentials. The verifiable credentials take up more storage space, but contain sufficient information for interoperability, so that the sender and receiver do not have to exchange any additionally required knowledge in order to interpret transmitted information. However, an ID wallet holder cannot verify whether a trust registry (e.g., a registry of entities authorized to issue a particular type of verifiable credential) which the verifiable credential links to and/or references is authentic or fake.

In the prior art, web browsers and operating systems have trust stores that have the function of mapping organizational trust anchors and managing digital certificates. Such organizational trust anchors are in most cases certificates that are created by certification bodies (also known as certificate authorities) using quality-assured procedures. These certificates issued by certification bodies are self-signed and are also called root certificates. Certification authorities are authorized by law and/or audits to issue root certificates. However, the audits and procedures underlying the creation of root certificates are unclear to most users of web browsers and operating systems. Furthermore, if a certification body is compromised, all users of its root certificates as trust anchors would be affected. This allows attackers to steal users' digital identities and login details.

U.S. Pat. No. 11,900,340 B1 describes decentralized networks and their application for the secure transfer of digital assets. The main focus is on managing decentralized identities to improve control over personal data. The process for managing secure digital identities is based on the principle of self-sovereign identity (SSI) using decentralized identifiers (DIDs) and verifiable login credentials. An identity wallet on a digital terminal is used to manage the decentralized identity and associated data. A hardware security module adds additional layers of security. One example is the use of a wallet hardware key that uses sensory inputs such as a fingerprint or a PIN to control access. An applet is used to manage and secure decentralized identifiers and associated data through the use of an applet-based API sharing mechanism within a secure environment. The document describes mechanisms for the secure and flexible sharing of digital credentials among different service providers and users, including the use of APIs and specific access controls defined by the user. The disadvantage is that private keys are stored in software and cannot be changed. Cryptographic calculations are performed decentrally. This means that the security of the cryptographic computations is not guaranteed.

EP 4 092 958 A1 discloses a method and a system for reading user attributes from an ID token by means of an ID provider and providing a verifiable digital credential with the user attributes that have been read in an ID wallet of a mobile terminal using an issuer service of a self-determined identity infrastructure (SSI infrastructure). The user attributes are stored in a protected memory area of the ID token. The SSI infrastructure includes a blockchain with a data schema and a public signature verification key assigned to the issuer service for verifying the digital credential or its signature. The mobile terminal sends a request to issue the digital credential to the issuer service so that the ID provider can read the user attributes from the ID token. The mobile terminal gives the ID provider read access to the user attributes in the ID token in order to forward the user attributes to the issuer service. The ID wallet receives the digital credential issued by the issuer service. The credential is structured in accordance with the data schema provided in the blockchain. In embodiments, the key material and digital credential encrypted therewith are stored on a security element in the mobile terminal. Only authorized services and applications can incorporate, add, modify and/or delete cryptographic means in the security element. The disadvantage is the use of blockchain technology, which uses a large amount of energy and large-scale use of which requires high computing power.

US 2008/0307515 A1 describes a method for authenticating a user, comprising the following steps:
sending an authentication request to a remote authentication apparatus;
generating a first piece of authentication information;
receiving the first authentication information in a terminal from an access terminal or the remote authentication apparatus;
generating second authentication information in the user's terminal that is at least partly based on the received first authentication information;
sending the second authentication information to the remote authentication apparatus;
validating the second authentication information and generating an authentication signal if validation has been successful. The disadvantage is that private keys are stored in software, which means they can be compromised.

DE 10 2011 110 898 A1 discloses methods for authenticating a user to grant access to services of a computer system, comprising:
sending an authentication request from a communication device associated with the user to an authentication server, the authentication request containing a transaction ID and a user ID identifying the user;
exchanging encrypted messages between the authentication server and the communication device, the authentication server using a cryptographic key belonging to the user identifier for encryption and the communication device using a cryptographic key specific to the authentication server for encryption;
determining an authentication result in the authentication server on the basis of the data contained in the exchanged encrypted messages;
sending the authentication result from the authentication server to the computer system and granting the user access to services of the computer system if authentication has been successful. An authentication application on the user's communication device comprises the private key. The disadvantage is that it is stored in software, which means it could be stolen by an attacker.

WO 2023/034284 A1 describes a system and a method for use in the implementation of self-determined digital credentials. A computer-implemented method for use in providing a verifiable credential to a trustor, comprising:
receiving an identity request from a trustor by means of an identity provider (IDP);
forwarding the identity request by means of the IDP to a user of an application on a mobile device of the user, the mobile device containing a verifiable credential;
receiving the verifiable credential from the mobile device by means of the IDP;
verifying the verifiable credential by means of the IDP on the basis of a public key linked to an issuer of the verifiable credential;
transferring an initial authorization of the verifiable credential to the trustor by means of the IDP;
receiving a request for identity data from the trustor by means of the IDP, the identity data request including a second authorization with respect to the verifiable credential; and
in response to the first authorization and the second authorization corresponding, transferring the identity data to the trustor. It is also possible for the verifiable credential to be signed by a private key. The disadvantage is that it is stored in software.

DE 10 2020 130 815 B3 discloses a method for selectively providing user data, comprising the following steps:
authenticating a user;
authorizing the provision of user data requested by a central unit (an authentication server or equivalent entity); and
providing the requested user data for transmission to the central unit, the authorization and provision of the requested user data being carried out by means of a decentralized apparatus (a mobile terminal or an equivalent terminal of the user), and the provision of the requested user data comprising encrypting user data stored on the decentralized apparatus, and the central unit not having the key to decrypt the encrypted user data.
   The method does not involve private keys and the decentralized identifiers are based on blockchain technology.

The disadvantage of the prior art is both the lack of self-sovereignty of the actors and the lack of security of their personal data and the digital certificates held by the actors.

The object is therefore to provide a system and a method that overcome the disadvantages of the prior art and prevent the forgery of digital credentials, and additionally enable copy protection for these credentials and for digital identities.

### BRIEF SUMMARY OF THE INVENTION

According to the invention, the object is achieved by a system having the features of claim 1, by a method having the features of claim 8, and by uses having the features of claim 15. Advantageous embodiments of the invention are specified in the dependent claims.

### BRIEF DESCRIPTION OF THE DRAWINGS

FIG. 1 is a schematic representation of different combinations of HSM (50), terminals (10/20/30/40) and connections between the HSM and terminals, wherein
a) shows an HSM (50) which is connected by means of an ISO 7816-3 connection (62) to a USB chip card reader (60), which is connected by means of a USB connection (61) to a digital terminal,
b) shows an HSM (50) which is integrated in a USB chip card reader (60) which is connected to a digital terminal by means of a USB connection (62),
c) shows an HSM (50) which is connected by means of an ISO 7816-3 connection (62) to a Bluetooth chip card reader (70), which is connected by means of a Bluetooth connection (71) to a digital terminal
d) shows an HSM (50) which is integrated in a Bluetooth chip card reader (70) which is connected to a digital terminal by means of a Bluetooth connection (71),
e) shows an HSM (50) connected to a digital terminal via an ISO 7816-3 connection (62)
f) shows an HSM (50) which is integrated in a digital terminal.

FIG. 2 is a schematic representation of an HSM (50), wherein the HSM comprises the application (200) that is running on the HSM and is linked to the installer's key registry (201), the identity key registry (202), the digital credentials registry (203) and the application-HSM interface (210).

FIG. 3 is a schematic representation of a digital terminal (10/20/30/40) having an ID wallet (300), wherein the ID wallet comprises a business process logic (320), the business process logic is linked to the user interface of the ID wallet (310), the credential store (350), the trusted credential store (360), the HSM-application programming interface (330) and the ID-wallet-to-ID-wallet communication interface (340), wherein the communication interface has a DIDComm interface (341) and an OpenID4VC interface (342), and the ID wallet is connected to a data transport interface (100) having a TCP/IP connection (110), a nearby share connection (120), a Wi-Fi direct connection (130), an AirDrop connection (140) and a Bluetooth connection (150).

FIG. 4 is a schematic representation of a digital terminal having an ID wallet (300), wherein the ID wallet has a business process logic (320), the business process logic is linked to the user interface of the ID wallet (310), the credential store (350), the trusted credential store (360) and the HSM-application programming interface (330), and the HSM-application programming interface is connected to an HSM (50) located outside the terminal by means of an application-HSM interface (210), and the HSM comprises an application (200).

FIG. 5 shows two mobile terminals, each having an ID wallet (300), wherein each ID wallet has a business process logic (320), the business process logic (320) is linked to the HSM-application programming interface of the ID wallet (330) and the ID-wallet-to-ID-wallet communication interface (340), wherein the communication interface has a DIDComm interface (341) and an OpenID4VC interface (342), and the two terminals are each connected to one another by means of the ID-wallet-to-ID-wallet communication interface (340).

FIG. 6 shows a digital credentials registry (203) having two registry entries (203.1 and 203.n), each having a tag-length-value structure, and each consisting of a first credential registry ID (203.x.1), a counter (203.x.2), a Boolean field (203.x.3), an X9.62 ECDSA signature: r-value of the signature (203.x.4) and an X9.62 ECDSA signature: S-value of the signature (203.x.5).

FIG. 7.1 shows a first part of a presentation of a credential anchored in the credential registry (203 (A)) of a party A to a party B with the following sequence (executed as a UML sequence diagram).

FIG. 7.2 shows a second part of the verification of the presentation of a credential anchored in the credential registry (203 (A)) of a party A to a party B by the party B, having the following sequence (executed as a UML sequence diagram).

### DETAILED DESCRIPTION OF THE INVENTION

A first aspect of the invention relates to a system for the secure issuance, receipt, presentation and verification of digital credentials between two actors of a common digital ID ecosystem, at least comprising:
at least one first, operationally non-manipulable hardware security module, which is constructed in such a way that its functions can only be controlled by using an application-HSM interface of a first application and that some of the data stored in registries managed by the first application cannot be generated, changed, or deleted at all and some can only be generated, changed or deleted by functions installed in the first application,
at least one first ID wallet comprising at least one ID-wallet-to-ID-wallet communication interface suitable for communication with at least one second ID wallet,
at least one first digital terminal on which the first ID wallet is installed, wherein the first ID wallet is connected to the first hardware security module by means of an ID wallet-HSM communication interface and is designed to communicate with a first application using the application-HSM interface,
at least one first application which is stored on the first hardware security module and is operatively non-manipulable and which is designed to establish, control and manage communication between the first hardware security module and the first digital terminal, as well as to carry out computing operations on the first hardware security module,
   wherein
the first hardware security module has at least one installer's key registry for storing at least one cryptographic key that is suitable for symmetrically encrypted communication between the first application stored on the first hardware security module and a second application stored on a second hardware security module by means of the first ID wallet and the second ID wallet equipped with at least one ID-wallet-to-ID-wallet communication interface that is suitable for communication with the first ID wallet,
the first hardware security module has at least one identity key registry for storing at least one private key,
the first hardware security module comprises at least one digital credentials registry, the digital credentials registry being suitable for containing digital credential registry entries, the registry entries including designations of digital credentials as well as hash values of these digital credentials, information about an issuer, signatures and statuses of these digital credentials,
the first hardware security module is configured to
   perform cryptographic computing operations,
   generate, store, delete and/or manage, by means of the first application, at least one self-sovereign identity (SSI) and at least one key pair belonging to the SSI and suitable for asymmetric encryption, the suitable key pair comprising a private key and a public key,
   manage at least one hash value calculated for the public key of the SSI, defined as a decentralized identifier (DID), in the ID wallet,
the first hardware security module
   prevents any transfer of private keys from or into the identity key registry of the first hardware security module, and
   allows transfers of public keys via the application-HSM interface.

The first application program is configured to generate pre-rotated keys and to store them in the identity key registry of the first hardware security module, the hardware security module having an application program-HSM interface which is designed to export public cryptographic keys, the digital credentials registry having signatures, at least one DID of an issuer and state parameters of the digital credentials registered in the memory area for digital credentials.

Preferably the system for the secure issuance, receipt, presentation and verification of digital credentials between two actors of a common digital ID ecosystem comprises the following:
at least one first, operationally non-manipulable hardware security module, which is constructed in such a way that its functions can only be controlled by using an application-HSM interface of a first application and the first application is configured to manage registries, wherein the registers are each designed as at least one installer's key registry for storing at least one cryptographic key, at least one identity key registry for storing at least one private key and at least one digital credentials registry,
at least one first ID wallet comprising at least one ID-wallet-to-ID-wallet communication interface suitable for communication with at least one second ID wallet,
at least one first digital terminal on which the first ID wallet is installed, wherein the first ID wallet is connected to the first hardware security module by means of an ID wallet-HSM communication interface and is designed to communicate with a first application using the application-HSM interface,
at least one first application which is stored on the first hardware security module and is operatively non-manipulable and which is designed to establish, control and manage communication between the first hardware security module and the first digital terminal, as well as to carry out computing operations on the first hardware security module,
   wherein
the first hardware security module has the at least one identity key registry and the at least one installer's key registry for storing at least one cryptographic key and the cryptographic key stored in the installer's key registry is configured to enable symmetrically encrypted communication between the first application stored on the first hardware security module and a second application stored on a second hardware security module by means of the first ID wallet and the second ID wallet equipped with at least one ID-wallet-to-ID-wallet communication interface,
the first hardware security module has the at least one identity key registry for storing at least one private key,
the first hardware security module comprises the at least one digital credentials registry, the digital credentials registry being configured to contain digital credential registry entries, the registry entries including designations of digital credentials as well as hash values of these digital credentials, information about an issuer, signatures and statuses of these digital credentials,
the first hardware security module is configured to
   perform cryptographic computing operations,
   generate, store, delete and/or manage and/or store in the identity key registry of the first hardware security module, by means of the first application, at least one self-sovereign identity (SSI) and at least one key pair and/or at least one pre-roted key belonging to the SSI and suitable for asymmetric encryption, the suitable key pair comprising a private key and a public key,
   manage at least one hash value calculated for the public key of the SSI, defined as a decentralized identifier (DID), in the first ID wallet,
the first hardware security module
   prevents any transfer of private keys from or into the identity key registry of the first hardware security module, and
   allows transfers of public keys via the application-HSM interface,
the first application program is configured to generate pre-rotated keys and to store them in the identity key registry of the first hardware security module, the hardware security module having an application program-HSM interface which is designed to export public cryptographic keys, the digital credentials registry having signatures, at least one DID of an issuer and state parameters of the digital credentials registered in the storage area for digital credentials.

Public keys can also be called PUKs.

Within the meaning of the invention, a digital credential is a set of one or more statements from an issuer. A verifiable digital credential (also called a verifiable credential) is a forgery-proof document of which the authorship can be cryptographically verified. Verifiable digital credentials can be used to create verifiable presentations that can also be cryptographically verified. The statements in a credential can refer to various topics. For example, they can be statements about authorization to use a service, resource or apparatus. Examples of digital credentials are digital identification documents (such as electronic proof of identity [eID], digital driving licenses, digital bank account access rights or the like), verification documents (such as official certificates, registry extracts, proof of authorization, official documents, or the like), or valuable digital credentials (such as digital promissory notes, digital currency, e.g. central bank digital currency (CBDC), digital direct debit authorizations, concert tickets, travel tickets, tickets in general).

Within the meaning of the invention, an actor may be an entity of various types. For example, actors can be natural persons, legal persons, organizations, companies, sovereign entities, authorities, subjects of international law or IoT objects. IoT stands for Internet of Things and IoT objects can also be designed as robotic, semi-autonomous or fully autonomous apparatuses. For example, an (autonomous or non-autonomous) vehicle and an electric charging station or unmanned fuel pump can each be IoT objects.

An ID ecosystem, within the meaning of the invention, is an ensemble of an interoperable, networked and/or networkable digital infrastructure that allows actors to authenticate themselves to one another, as well as to manage, present and/or transfer digital evidence to one another.

Within the meaning of the invention, hardware security modules (HSM) are computing devices that have at least one cryptoprocessor. Secure, cryptography-relevant components of other processors (e.g. CPU or GPU) are not hardware security modules within the meaning of the invention. Compared with other processor types, HSMs are particularly resistant to manipulation and are also protected against unauthorized physical access to the data stored therein. An HSM may also be filled with self-leveling materials, and the cryptoprocessors of an HSM may be designed so that keys stored thereon are erased or reset to a default value (e.g., a series of zeros) when an attempt is made to remove the encapsulation. The encapsulation process, as well as the encapsulated material itself, is also called potting. Electrical conductors of HSMs are also as short as possible to make side-channel attacks by intercepting electromagnetic radiation emitted by cryptographic operations more difficult.

Data stored in the registries can in part not be generated, modified or deleted at all and can in part only be generated, modified or deleted by functions installed in the first application

For example, chip cards (smart cards or chip cards), dongles and/or USB sticks can have an HSM.

In embodiments of the system, the application is designed as an applet.

Within the meaning of the invention, the ID wallets are each the combination of software for managing verifiable digital credentials with a memory area on the hardware that is assigned to the software and is managed by the software and intended for storing digital credentials, on which hardware the software runs. The ID wallet can be stored and executed on the digital terminal, or stored on separate hardware, the separate hardware being connected to the terminal in order to use the ID wallet and the ID wallet being operated via the mobile terminal.

Within the meaning of the invention, the digital terminals can each be a mobile computing unit (e.g. a smartwatch, a mobile phone, a smartphone, a phablet, a tablet computer, a netbook, a notebook, a card reader or a ticket scanner), a desktop computer, an unattended computing unit (e.g. an IoT device), a computer for automated data processing (e.g. a server or a computing cluster).

The communication interface can be, for example, a DIDComm interface or an OpenID4VC interface.

The HSM and the digital terminals can be connected to one another by means of a communication connection known in the prior art. These can be, for example, a USB connection, a USB chip card reader, an ISO 7816-3 connection, a Bluetooth connection, a Bluetooth chip card reader, a WLAN connection, an adapter, an Ethernet connection, an Internet connection, a near-field communication connection, an AirDrop connection or a nearby share connection. The communication can also be an ad-hoc network. The HSMs can also each be integrated into the digital terminal without being integrated into other processors of the terminal. Within the context of this application, the statement that an HSM is connected to a terminal device can also refer to HSMs that are integrated into a terminal.

The HSMs each have an installer's key registry for storing at least two, preferably four or more, cryptographic keys for symmetrically encrypted communication with a second HSM.

In embodiments, the installer's key registry of each HSM is designed to contain between 2 and 256 cryptographic keys.

The installer's key registry, the identity key registry and the digital credentials registry may each comprise or consist of a file.

The digital credentials registry (also called credential registry) stores the signatures, issuer DIDs and status parameters of the digital credentials registered in the digital credential memory area.

The digital credential hash values are, within the meaning of the invention, values that are determined applying a hash function (hash value function) to the digital credential. A hash function uses the data that makes up a digital credential to determine a string of characters of a certain length, the string of characters taking up less storage space than the digital credential itself. This string of characters is the hash value. The hash function is designed so that each digital credential corresponds to a unique hash value. Any change or manipulation of a digital credential would result in a different hash value when a hash function is applied to this credential.

Within the meaning of the invention, asymmetric encryption is an encryption process that is based on at least one key pair, which comprises a public and a private, secret key. An actor 1 can encrypt information with the public key of an actor 2. The information encrypted in this way can only be decrypted with the private key of the actor 2.

Managing the hash value defined as a decentralized identifier (DID) may include creating, storing, or deleting it.

In embodiments of the system, the first ID wallet is designed to store the digital credential memory area managed thereby on the first digital terminal such that it is encrypted using a cryptographic key of the first ID wallet, the cryptographic key of the first ID wallet being stored not on the first digital terminal but on the first HSM.

In embodiments of the system, the first ID wallet is designed to enable data to be output to a holder of the first ID wallet and data to be input by the holder of the first ID wallet by means of the user interface of the ID wallet.

The first HSM and/or the second HSM do not have an interface via which cryptographic keys that serve as the basis of a DID can be imported into each HSM or private cryptographic keys can be exported from each HSM.

The fact that the HSM is operationally non-manipulable means that the keys stored in the installer's key registry cannot be read and/or changed by an actor using direct physical access and that only an installer can exchange keys stored in the installer's key registry using software control.

In embodiments of the system, the first ID wallet has at least one memory which is suitable for containing encrypted digital credentials, keys for encrypting the digital credentials being stored in the hardware security module, and the memory having
at least one first memory area for digital credentials for verifiable digital credentials issued to the holder of the first ID wallet, and
at least one second memory area for trustworthy digital credentials and/or chains of credentials issued to actors classified as trustworthy by the holder of the first ID wallet, the trustworthy digital credentials and/or chains of credentials each having at least one first public cryptographic key.

In embodiments of the system, the first ID wallet has at least one memory which is suitable for containing encrypted digital credentials, keys for encrypting the digital credentials being stored in the first hardware security module, and the memory having
at least one first memory area for verifiable digital credentials issued to the holder of the first ID wallet, and
at least one second memory area for trustworthy digital credentials and/or chains of credentials which are issued to actors classified as trustworthy by the holder of the first ID wallet, the trustworthy digital credentials and/or chains of credentials each having at least one first public cryptographic key.

Verifiable digital credentials issued to the holder of the first ID wallet may, for example, be evidence of properties or attributes of the holder, such as proof of age, date of birth or proof of their name. The verifiable digital credentials issued to the holder of the first ID wallet can also contain Boolean values, such as the answer to the question as to
whether the holder of the first ID wallet has exceeded a certain age, or
whether the holder of the first ID wallet belongs to a group.

In the second memory area, digital credentials are stored after they have been presented to the ID wallet by another actor, successfully cryptographically verified by the ID wallet in terms of their integrity, and classified as trustworthy by the actor. Such a digital credential contains a public cryptographic key that is linked to a digital identity that is also named in the digital credential. In terms of an authorization to represent, such a digital credential may contain rights to issue and/or control credential types referenced in the digital credential on behalf of an issuing digital identity. These digital credentials can reference other digital credentials in the second memory area. In contrast to the trust store of a web browser, the second memory area of the ID wallet does not store certificates that state anything about the assignment of a URL to an entity or a server, but rather verifiable digital credentials that state something about the assignment of a DID to a public key and, if applicable, to a real-world actor and, if applicable, to another DID associated with this DID.

The second memory area of the ID wallet enables the decentralized transfer of organizational trust anchors. Instead of trusting a completely unknown certification service, for example in another country, the wallet holder can base their digital trust on organizations that they know and that they also trust in the real world itself. For example, a municipality can distribute trusted digital credentials from other municipalities, provided with a public key, to the ID wallets of its citizens. Through chains of trust that develop from municipality to municipality, trust can spread in the digital space and be reflected in the second memory area of an ID wallet. In addition, the second memory area of the ID wallet is filled by trusted contacts of the holder. When a verifiable credential is stored in the first memory area, the associated chain of credentials, which is transmitted with the verifiable credential, up to the digital credential of the issuer, which is provided with a public key, is simultaneously stored in the second memory area of the ID wallet.

A chain of credentials is a series of two or more credentials, of which each credential in the series, except for the last credential references at least the next credential so that all pieces of credentials in the chain of credentials are at least indirectly linked by means of references.

In embodiments, the ID wallet may have at least one third memory area. If an actor is a verifier for at least one verifiable digital credential of another actor, the verifiable credential is stored in the third memory area and, if necessary, deleted from the third memory area after completion of the verification process.

If an actor is an issuer of at least one verifiable digital credential, copies of issued verifiable digital credentials may be stored in another memory area. This is particularly advantageous for the purpose of revoking verifiable digital credentials.

In embodiments, at least one verifiable credential is present in the ID wallet so as to be encrypted using at least one symmetric key.

In embodiments, the first memory area and/or the second memory area may be stored using one or more symmetric keys stored in the digital credentials registry of the HSM.

The verifiable credentials bear signatures of their issuers.

In embodiments of the system, verifiable digital credentials enable the assignment of public cryptographic keys to corresponding digital identities.

In embodiments of the system, verifiable digital credentials enable verifiable statements to be made about assignments of DIDs to corresponding actors.

In embodiments of the system, the first application is designed to generate and/or manage verifiable digital credentials in the memory of the first ID wallet, the verifiable digital credentials comprising an assignment to a DID of the issuer.

In embodiments of the system, the first application is designed to sign verifiable digital credentials in the memory of the first ID wallet, the application of the first hardware security module being configured to
generate and/or manage at least one cryptographic key, where the key serves to sign and/or verify at least one verifiable digital credential in the first ID wallet
establish a secure communication between the first hardware security module and the second hardware security module by means of symmetric and asymmetric cryptography, wherein the encryption is carried out by the first hardware security module.

In embodiments of the system, the first ID wallet is designed to cryptographically verify the integrity of trusted digital credentials which have a public cryptographic key and of which the public cryptographic key is associated with a digital identity cited in the trusted digital credential, and the system is designed to store such trusted digital credentials in the first ID wallet.

In embodiments of the system, verifiable digital credentials include an association with a DID of the holder and/or an association with a DID of the verifier.

Within the meaning of the invention, a verifier is an actor who checks a verifiable credential of a holder, in particular for authenticity and validity.

Managing verifiable digital credentials includes, in particular, storing, deleting and/or reading them.

In embodiments of the system, the wallets digital credentials stored in the first and/or second memory area are designed to be symmetrically encrypted using one of the symmetric cryptographic keys.

In embodiments of the system, the first ID wallet is designed to cryptographically verify and store the integrity of trusted digital credentials which have a public cryptographic key and of which the public cryptographic key is associated with a digital identity cited in the trusted digital credential.

In embodiments of the system, the second memory area is designed to contain digital credentials that reference one or more other digital credentials contained in the second memory area.

In embodiments of the system, the hardware security module is configured to execute the first application, the first application being designed to generate the public cryptographic keys and/or pre-rotated keys provided by the verifiable digital credentials and to store them in an identity key registry of the hardware security module, the hardware security module comprising the application-HSM interface, which is configured to export public cryptographic keys.

A pre-rotated key is a key intended for later use that has not yet been used for decryption, signing, or encryption, but has been signed with a current key that is used for signing and/or decryption and/or encryption.

Preferably, a new public-private key pair is generated for later use during key pre-rotation. The newly generated public key intended for later use is signed using the current private key. If the old key pair becomes invalid, the holder of the new key pair can be authenticated to other actors using the new public key signed with the previous private key.

In embodiments of the system, the ID-wallet-to-HSM communication interface of the first ID wallet is designed as a first HSM-application programming interface (API). The HSM-application programming interface of the first ID wallet is designed to enable data to be exchanged between the first application and the first ID wallet.

In embodiments of the system, the HSM has an application-HSM interface. The ID wallet on the digital terminal communicates with the application using the HSM-application programming interface and the application-HSM interface.

In embodiments of the system, the first hardware security module is designed to communicate with the second hardware security module connected to the second ID wallet via the first ID wallet, which is designed to communicate with a second ID wallet provided by a second terminal (10a) by means of at least one communication protocol.

In embodiments, this communication protocol may be selected by way of example, but not exclusively, from the DIDComm-V.2 or OpenID4VC protocols.

In embodiments of the system, the verifiable digital credentials each have a DID for the issuer, and
the first application is configured such that only the application provided by the second hardware security module is enabled to store digital credential registry entries in the digital credentials registry of the first hardware security module, these registry entries either coming directly from the issuer and the first application checking whether the entry has been signed by the first application or the registry entries are marked as transferable, and/or
can be issued to a DID of the holder of the first ID wallet and the first application is configured to store or delete the hash value for the verifiable digital credential in the digital credentials registry, the registry entries for verifiable digital credentials having at least one status variable, the status of the status variable determining whether each verifiable digital credential can be copied and/or lent and/or transferred by the first ID wallet to the second ID wallet.

In embodiments of the system, the verifiable digital credentials each have a DID for the issuer, and
the first application is configured such that only the application provided by the second hardware security module is enabled to store digital credential registry entries in the digital credentials registry of the first hardware security module, these registry entries either coming directly from the issuer and the first application checking whether the entry has been signed by the second application or the registry entries are marked as transferable, and/or
are issued to a DID of the holder of the first ID wallet and the first application is configured to store or delete the hash value for the verifiable digital credential in the digital credentials registry, the registry entries for verifiable digital credentials having at least one status variable, the status of the status variable determining whether each verifiable digital credential can be copied and/or lent and/or transferred by the first ID wallet to the second ID wallet.

In embodiments of the system, the application is not changeable and data in a first part of the memory of the first hardware security module can only be created, changed or deleted by means of the application and data cannot be created, changed or deleted in a second part of the memory.

In embodiments of the system, the installer's key registry of the first hardware security module has at least one first non-readable secret symmetric key (hereinafter also referred to as the first installer's key), which is designed to enable the creation of at least one communication key for encrypted communication with the second hardware security module by means of the first terminal and the second terminal using a symmetric encryption method, the second hardware security module having an installer's key registry and the installer's key registry of the second hardware security module having the same non-readable secret symmetric key as the installer's key registry of the first hardware security module. The symmetric encryption method is preferably the Diffie-Hellman method.

In embodiments of the system, the installer's key registry of the first hardware security module has at least one second non-readable secret symmetric key which is designed to carry out changes by an installer in the installer's key registry of the first hardware security module.

The installer can use the second non-readable secret symmetric key to obtain access authorization, preferably in order to
update, maintain and/or otherwise modify the application, and
replace keys.

The fact that only the installer is in possession of the second, non-readable secret symmetric key ensures that the HSM cannot be operatively manipulated.

A further aspect of the invention relates to a method for secure communication between two systems for the verification and/or transmission of digital credentials, in particular verifiable digital credentials, wherein the first ID wallet is connected to the first hardware security module and the second ID wallet is connected to the second hardware security module, the application of the first hardware security module
generating and/or managing at least one cryptographic key, the key being used to encrypt and/or decrypt and/or sign and/or verify at least one verifiable digital credential in the first ID wallet,
establishing secure communication by means of asymmetric cryptography, the encryption process being carried out by the first hardware security module and each hardware security module preventing any transfer of private keys from or into the key registry, and
preventing the application of the first hardware security module from changing the content of its own digital credentials registry.

In a preferred method for secure communication between two systems for the verification and/or transmission of digital credentials, in particular verifiable digital credentials, the first ID wallet is connected to the first hardware security module and the second ID wallet is connected to the second hardware security module, wherein the application of the first hardware security module
generates and/or manages at least one cryptographic key, the key being used to sign and/or verify at least one verifiable digital credential in the first ID wallet,
establishes secure communication by means of symmetric and asymmetric cryptography between the first hardware security module and the second hardware security module, the encryption process being carried out by the first hardware security module and each hardware security module preventing any transfer of private keys from or into the key registry, and
prevents the application of the first hardware security module from itself writing contents into its own digital credentials registry,
generates at least one pre-rotated key and stores it in the identity key registry wherein the first hardware security module has the application-HSM interface, the application-HSM interface exports public cryptographic key, wherein the digital credential registry has signatures, at least one DID of an issuer and status parameters for digital credentials stored in the in the memory area for digital credentials.

Managing cryptographic keys may include storing and/or deleting them.

In embodiments of the method, the status of at least one status variable of at least one registry entry in the digital credentials registry of the first hardware security module characterizes the at least one verifiable digital credential associated with this registry entry in the memory area for digital credentials of the first ID wallet as
being copyable or non-copyable, and/or
being transferable or non-transferable to the second ID wallet, and/or
being lendable or non-transferable to the second ID wallet.

In embodiments of the method, the status of at least one status variable of at least one registry entry in the digital credentials registry of the first hardware security module characterizes the at least one verifiable digital credential associated with this registry entry in the first ID wallet as
being copyable or non-copyable, and/or
being transferable or non-transferable to the second ID wallet, and/or
being lendable or non-transferable to the second ID wallet.

In embodiments of the method, the at least one verifiable digital credential in the memory area for digital credentials of the first ID wallet as
being copyable or non-copyable, and/or
being transferable or non-transferable to the second ID wallet, and/or
being lendable or non-transferable to the second ID wallet.

In embodiments, the method for communication between two systems comprises the steps of:
generating the one or more secret temporary symmetric cryptographic keys designed to encrypt the exchange of information between the first hardware security module and the second hardware security module,
generating, by means of the first application, the at least one key pair suitable for asymmetric encryption as the root of an SSI, generating and/or storing and/or deleting and/or managing at least one DID by means of the first application using the public key of the SSI,
connecting the at least one SSI in the ID wallet to the at least first hardware security module.

The information is exchanged by means of the first terminal connected to the first HSM and the second terminal connected to the first terminal and to the second HSM.

In embodiments of the method, the digital credentials are stored in the first ID wallet so as to be encrypted using a cryptographic key.

In embodiments of the method, data is output to the holder of the first ID wallet and data is input by the holder of the first ID wallet by means of a front end.

Advantageously, the front end can be designed as a user interface, particularly preferably as a graphical user interface on the first terminal.

In embodiments of the method,
verifiable digital credentials issued to the holder of the first ID wallet are stored in the first memory area for digital credentials, and/or
trustworthy digital credentials and/or chains of credentials issued to actors classified as trustworthy by the holder of the first ID wallet are stored in the second memory area of the first ID wallet, the trustworthy digital credentials and/or chains of credentials each having at least the one first public cryptographic key.

In embodiments of the method,
the application running on the first hardware security module encrypts at least one digital credential with a symmetric software key generated by the first ID wallet on the basis of a random value,
the key thus generated is encrypted by the application running on the first hardware security module, a derived key being generated from
   the at least one private key stored in the first identity key registry,
   the public key of a private key stored in a second identity key registry located on the second hardware security module,
   the at least first non-readable secret symmetric key of the first installer's key registry,
   the random value,
the encrypted digital credential with which the symmetric software key transmitted in encrypted form to the second hardware security module using the derived key,
the second ID wallet extracts the encrypted symmetric software key together with the random value and transmits the encrypted symmetric software key together with the random value to the second hardware security module,
the second application generates a symmetric key from
   the at least one private key stored in the second identity key registry,
   the public key of the private key used, which is stored in a first identity key registry located on the first hardware security module,
   the at least first non-readable secret symmetric key of the first installer's key registry,
   the random value,
the second application uses the symmetric key thus formed to decrypt the symmetric software key and transmits it to the second ID wallet,
the second ID wallet decrypts the digital credential using the symmetric software key.

In embodiments of the method,
the first ID wallet encrypts at least one digital credential with a symmetric software key generated by the first ID wallet on the basis of a random value,
the key thus generated is encrypted by the first ID wallet, a derived key being generated from
   the at least one private key stored in the first identity key registry,
   the public key of a private key stored in a second identity key registry located on the second hardware security module,
   the at least first non-readable secret symmetric key of the first installer's key registry,
   the random value,
the encrypted digital credential with which the symmetric software key transmitted in encrypted form to the second hardware security module using the derived key,
the second ID wallet extracts the encrypted symmetric software key together with the random value and transmits the encrypted symmetric software key together with the random value to the second hardware security module,
the second ID wallet generates a symmetric key from
   the at least one private key stored in the second identity key registry,
   the public key of the private key used, which is stored in a first identity key registry located on the first hardware security module,
   the at least first non-readable secret symmetric key of the first installer's key registry,
   the random value,
the second application uses the symmetric key thus formed to decrypt the symmetric software key and transmits it to the second ID wallet,
the second ID wallet decrypts the digital credential using the symmetric software key.

In embodiments of the method,
the first ID wallet and/or the application running on the first hardware security module encrypts at least one digital credential with a symmetric software key generated by the first ID wallet on the basis of a random value,
the key thus generated is encrypted by the first ID wallet and/or by the first hardware security module, a derived key being generated from
   the at least one private key stored in the first identity key registry,
   the public key of a private key stored in a second identity key registry located on the second hardware security module,
   the at least first non-readable secret symmetric key of the first installer's key registry,
   the random value,
the first ID wallet and/or the first hardware security module transmits the digital credential that is encrypted with the random value together with the symmetric software key that is encrypted with the derived key to the second ID wallet and/or to the second hardware security module,
the second ID wallet extracts the encrypted symmetric software key together with the random value and transmits the encrypted symmetric software key together with the random value to the second hardware security module,
the second ID wallet and/or the second application generates a symmetric key from
   the at least one private key stored in the second identity key registry,
   the public key of the private key used, which is stored in a first identity key registry located on the first hardware security module,
   the at least first non-readable secret symmetric key of the first installer's key registry,
   the random value,
the second application uses the symmetric key thus formed to decrypt the symmetric software key and transmits it to the second ID wallet,
the second ID wallet decrypts the digital credential using the symmetric software key.

The random value can be a randomly generated string of characters and is also called a salt.

In embodiments of the method, the first ID wallet generates and/or manages verifiable digital credentials using the first application and the cryptographic keys of the first decentralized identity used, which are managed by said first application program, the verifiable digital credentials
including an assignment of public cryptographic keys to a digital identity, and/or
making a verifiable statement regarding the assignment of the issuer's DID to at least one actor.

The management process may also include storage and/or deletion processes.

In embodiments of the method, the first memory area for digital credentials for the digital credentials issued to the holder of the first ID wallet is symmetrically encrypted by the first application using one of the symmetric cryptographic keys.

In embodiments of the method, the first ID wallet cryptographically verifies the integrity of the trusted digital credentials which have a public cryptographic key and of which the public cryptographic key is linked to a DID cited in the trusted digital credential, the trusted digital credentials being designed as verifiable digital credentials and the system storing such verifiable digital credentials in the first ID wallet.

In embodiments of the method, digital credentials are stored in the first memory area and/or in the second memory area, which reference one or more other digital credentials stored in the second memory area.

In embodiments of the method, the first hardware security module executes the first application and the first application generates the at least one key pair suitable for asymmetric encryption and/or at least one pre-rotated key associated with the at least one SSI and stores the key pair and/or the pre-rotated key in the identity key registry of the first hardware security module, the application exporting public cryptographic keys stored on the hardware security module by means of the interface.

In embodiments of the method, the first hardware security module executes the first application and the first application generates the at least one key pair suitable for asymmetric encryption and/or at least one pre-rotated key associated with the at least one DID and stores the key pair and/or the pre-rotated key in the identity key registry of the first hardware security module, the application exporting public cryptographic keys stored on the hardware security module by means of the interface.

The asymmetric key pair associated with a DID that is suitable for an asymmetric encryption is associated with an SSI.

In embodiments of the method, the ID-wallet-HSM communication interface is designed as an HSM-application programming interface and the first ID wallet communicates with the first application by means of the HSM-application programming interface and thus exchanges data between the first application and the first ID wallet.

In embodiments of the method, the first ID wallet communicates with the first application by means othe ID-wallet-HSM communication interface over the application-HSM interface and and thus enables an exchange of data between the first application and the first ID wallet.

In embodiments, the digital credentials registry consists of a sequence of registry entries that can be randomly read by the application. The number is determined by the memory size of the HSM. Each registry entry is a type-length-value structure, also called a tag-length-value structure (TLV), and consists of:
a 256-bit credential registry entry identifier
a 64-bit unsigned integer counter
an 8-bit Boolean field for rights management for the holder
r-value of a X9.62 ECDSA signature of the issuer of the digital credential.
S-value of the X9.62 ECDSA signature

The identification number of the credential registry entry (CRE-ID) is 32 bytes long. The ID is generated from the signature of the associated digital credential. In order to create a uniform length for different signature methods, this signature is hashed using SHA 256 and stored as a BER OCTET STRING. The credential is managed via an 8-bit Boolean field. The individual bits are used as follows:
0b00000001 copyable; the credential can be duplicated
0b00000010 lendable; the credential can be lent; status bit “lent” must also be checked.
0b00000100 transferable; the credential can be transferred to (stored on) another HSM
0b01000000 lent (status bit).
0b10000000 invalid/flagged for deletion (status bit)

The signature of the credential registry entry is created in the issuer's HSM using the same private key that is also used to sign the associated digital credential.

In embodiments of the method, when presenting a verifiable credential as a digital original using two applications running on the HSM, the application running on the HSM of the credential holder provides proof of the current ownership of the credential to the HSM of the credential verifier by encrypted transmission of the credential registry entry. The following process takes place between a credential holder (A) and a credential verifier (B):
1.1 (A) sends an invitation message (e.g. DIDComm-Invitation) and transmits a DID document with its own public key (PUK) therein. Alternatively, (B) can also send the invitation message. In this case, (B) sends the present proof request after (A) has sent the response to the invitation.
1.2 (A) receives the response to the invitation together with the present proof request. This contains the DID document of (B) with B's public key and a random value as the salt as an initial vector for generating a session key.
1.3.1 This is instructed by the application running on the HSM of (A) to generate by transmitting the parameter own DID of (A) to reference the own DID to be used, the DID of (B), the PUK of the DID of (B) and a reference of the cryptography algorithm to be used.
1.3.2 The application program running on the HSM of (A) generates the derived key (der) therefrom. The derived key is generated from the private key of the referenced DID of (A), the PUK of the DID of (B), and the first installer key (Installateur.symKey) and keeps it in the session (only DIDs and salt are transmitted). The application running on the HSM confirms the key generation (ack).
1.4 The ID wallet of A generates the symmetric software key (ssk) for message encryption from the transmitted salt.
1.5.1 The ID wallet of A allows the application running on the HSM of A to encrypt the ssk using the derived key (der)→enc(der,ssk)
1.5.2 The ID wallet of A receives the encrypted symmetric software key enc(der,ssk) for each credential to be presented, the following sequence is run through:
1.6.1 The ID wallet of A sends a request to the application running on the HSM of A to prove ownership of the credential
   1.6.1.1 the application loads the credential registry entry (CRE) from the credential registry
   1.6.1.2 the application receives the CRE from the credential registry
1.6.2 the application encrypts the CRE using the derived key der
1.6.3 The ID wallet generates a message (e.g. DIDComm-PresentProof) for presenting the credential from the credential entry received from the application in encrypted form, has it signed by the application using the private key of the DID used by A, and
1.7 encrypts the message with the ssk (enc(der,ssk)). Each message has its own key.
1.8 The ID wallet of A transmits the encrypted message to the ID wallet of B for presentation purposes.
2.1.1 B's ID wallet (300b) sends a key derivation request for the derived key to the application (200b) running on the HSM
2.1.2 In the application (200b) running on the HSM (50b) of B (the verifier), the derived key (der) is derived. This takes place analogously to step 1.3.2, except that the PUK of DID (A) and the private key of DID (B) are used.
2.2 B's ID wallet (300b) loads the PUK of A's DID
2.3 B's ID wallet (300b) verifies the signature of A via the presentation for each presented credential, the following sequence is run through:
2.4.1 Loading the issuer credential chain from the presentation. The issuer credential is referenced by the presented credential and documents the DID and the legitimacy of the issuer. Through the structure of the issuer organization and the documentation of key rotations, a plurality of credentials can reference one another sequentially and form a chain.
2.4.2 checking the issuer credential chain:
1. Checking the cryptographic consistency of the chain
2. Checking for the presence of a DID of the chain in the trusted digital credential memory area (360b) of B's ID wallet (300b)—this determines the trustworthiness of the issuer.
2.4.3 Loading the issuer's PUK (PUK.issuer) from the issuer credential chain attached to the credential
2.4.4 Verifying the signature of the presented credential using the PUK.issuer
   2.4.5.1 Extracting the encrypted CRE of the credential from the presentation and pass it to the application (200b) running on the HSM (50b)
   2.4.5.2 in B's HSM (50b), the CRE of the credential is decrypted using the derived key (der) ((der); see 2.1.2)
   2.4.5.3 The application (200b) checks the concatenation of the CRE with the credential (Hash(Sig(Cred))=ID.RegEntry+proof(PUK.issuer; Sig(RegEntry))=true), where
1. Sig(RegEntry)=s-value of the signature
2. r-value(random)=salt
3. Counter=max present counter
4. X9.62 ECDSA value of the signature=container of the r- and s-values
2.4.5.4 The application (200b) evaluates the transferred Boolean field
2.4.5.5 The application (200b) transfers the overall result of the checks to B's ID wallet (300b)
3 Response from B's ID wallet (300b) to A's ID wallet

A DID document is a record that describes the DID, including mechanisms such as cryptographic public keys that the DID can use to authenticate itself and prove its link to the DID.

A further aspect of the invention relates to the use of a system for the secure exchange of digital credentials between two actors of a common digital ID ecosystem and/or to a method for secure communication between two such systems for the verification and/or transmission of digital credentials, in particular verifiable digital credentials, characterized in that the first ID wallet is connected to the first hardware security module and the second ID wallet is connected to the second hardware security module, for the issuance and/or presentation and/or verification of tickets, official documents, tokens, access authorizations and/or promissory notes, and as digital currency, such as central bank digital currency (CBDC).

A preferred use of a system for the secure exchange of digital credentials between two actors of a common digital ID ecosystem and/or to a method for secure communication between two such systems is for issuing and/or presenting and/or verifying tickets, official documents, tokens, promissory notes and/or digital currency.

The digital claims are especially selected from tickets, certificates, official documents, deeds, charters, tokens, access authorizations, bonds, vouchers, IOUs and/or digital currency.

In embodiments of the use, the digital credentials are designed as verifiable digital credentials and the first ID wallet is connected to the first hardware security module and the second ID wallet is connected to the second hardware security module.

In embodiments, the computer program product implements the use according to the invention.

A further aspect of the invention relates to a computer program product which implements the method according to the invention and, if applicable, the above-mentioned applications.

In embodiments, this computer program product is part of the system according to the invention. Another aspect is a data carrier or data processing plant on which the computer program product is stored and/or installed.

In embodiments, the first HSM and/or the second HSM is
a chip card selected from the acs ACOSJ-DI 95K and/or from the Javacard 3.0.4 and up, and/or
an eSIM selected from the NXP EdgeLock SE050 and/or Javacard 3.0.5, and/or an acs ACR39T USB-C dongle
a USB-A dongle, selected from an identiv uTrust-Token Standard chip card in ID-000 format and/or an acs ACR39U chip card in ID-1 format
a Bluetooth dongle with an AirID 2 mini chip card in ID-000 format

In embodiments, the first digital terminal and/or the second digital terminal is/are a smartphone selected from a Samsung Galaxy A53 and/or iPhone 14 PRO.

All HSMs mentioned in the previous paragraph are expediently
compatible with one another within the meaning of the invention, provided that the application according to the invention is installed thereon, and
compatible with the smartphones mentioned in the previous paragraph, provided that the ID wallet according to the invention is installed thereon.

The smartphones mentioned in the previous paragraph are expediently also compatible with one another, provided that the ID wallet according to the invention is installed thereon.

The invention is not limited to the illustrated and described embodiments but also includes all embodiments which act identically within the meaning of the invention. Furthermore, the invention is also not limited to the especially described feature combinations but can also be defined by any other combination of particular features of all individual features disclosed overall, provided that the individual features are not mutually exclusive, or a specific combination of individual features is not explicitly excluded.

### EXEMPLARY EMBODIMENTS

The invention is explained in more detail below with reference to an exemplary embodiment. The embodiment relates to the presentation of proof of ownership of a verifiable credential by a party A to a party B and is intended to describe the invention without limiting it.

The invention is explained in more detail with reference to drawings. In the drawings:

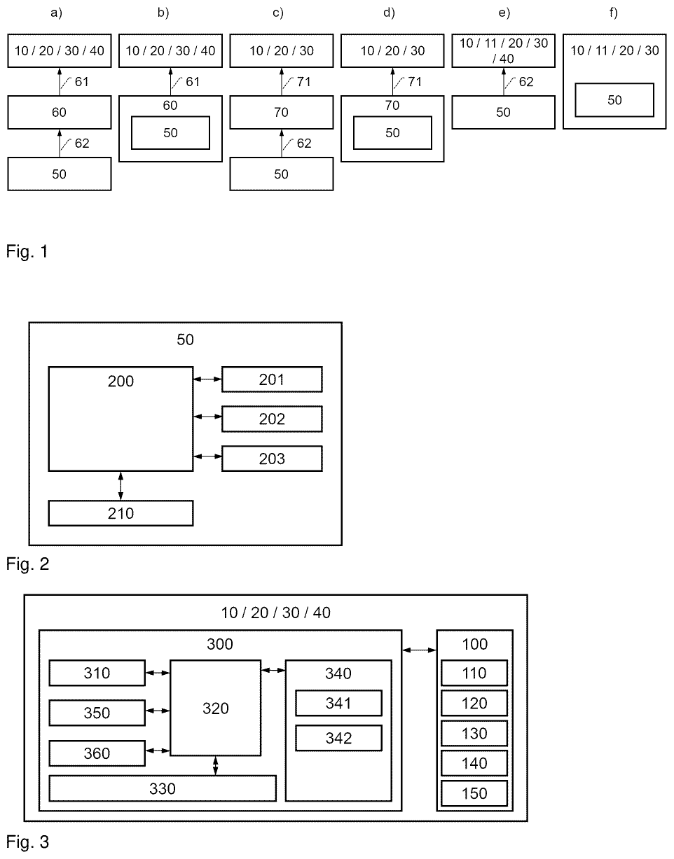

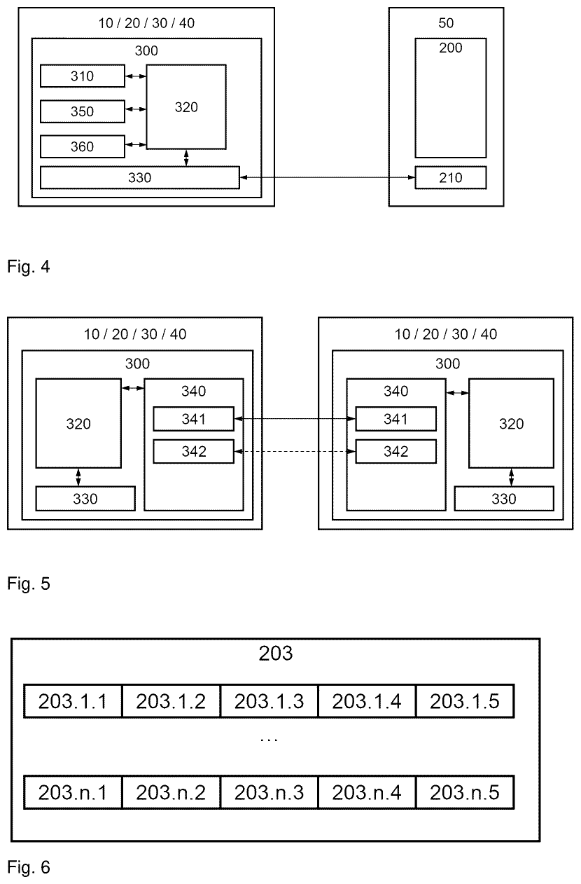

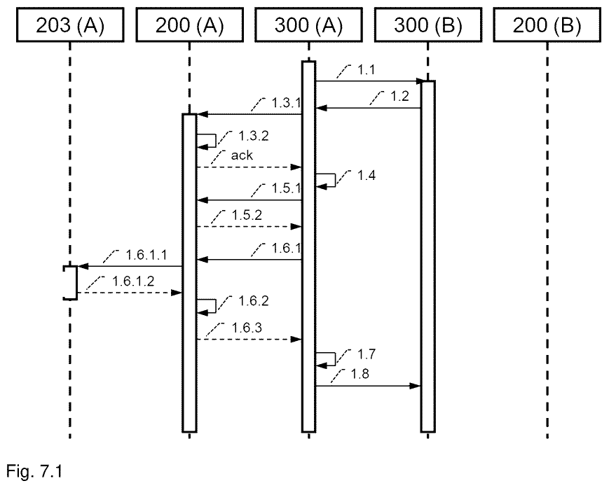

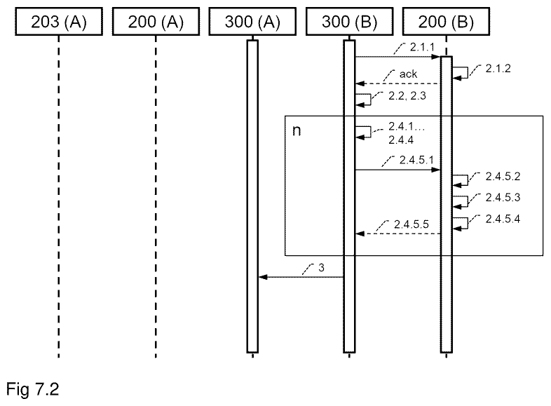

FIG. 1 is a schematic representation of different combinations of HSM (50), terminals (10/20/30/40) and connections between the HSM and terminals, wherein
a) shows an HSM (50) which is connected by means of an ISO 7816-3 connection (62) to a USB chip card reader (60), which is connected by means of a USB connection (61) to a digital terminal,
b) shows an HSM (50) which is integrated in a USB chip card reader (60) which is connected to a digital terminal by means of a USB connection (62),
c) shows an HSM (50) which is connected by means of an ISO 7816-3 connection (62) to a Bluetooth chip card reader (70), which is connected by means of a Bluetooth connection (71) to a digital terminal
d) shows an HSM (50) which is integrated in a Bluetooth chip card reader (70) which is connected to a digital terminal by means of a Bluetooth connection (71),
e) shows an HSM (50) connected to a digital terminal via an ISO 7816-3 connection (62)
f) shows an HSM (50) which is integrated in a digital terminal,
FIG. 2 is a schematic representation of an HSM (50), wherein the HSM comprises the application (200) that is running on the HSM and is linked to the installer's key registry (201), the identity key registry (202), the digital credentials registry (203) and the application-HSM interface (210),
FIG. 3 is a schematic representation of a digital terminal (10/20/30/40) having an ID wallet (300), wherein the ID wallet comprises a business process logic (320), the business process logic is linked to the user interface of the ID wallet (310), the credential store (350), the trusted credential store (360), the HSM-application programming interface (330) and the ID-wallet-to-ID-wallet communication interface (340), wherein the communication interface has a DIDComm interface (341) and an OpenID4VC interface (342), and the ID wallet is connected to a data transport interface (100) having a TCP/IP connection (110), a nearby share connection (120), a Wi-Fi direct connection (130), an AirDrop connection (140) and a Bluetooth connection (150),
FIG. 4 is a schematic representation of a digital terminal having an ID wallet (300), wherein the ID wallet has a business process logic (320), the business process logic is linked to the user interface of the ID wallet (310), the credential store (350), the trusted credential store (360) and the HSM-application programming interface (330), and the HSM-application programming interface is connected to an HSM (50) located outside the terminal by means of an application-HSM interface (210), and the HSM comprises an application (200), FIG. 5 shows two mobile terminals, each having an ID wallet (300), wherein each ID wallet has a business process logic (320), the business process logic (320) is linked to the HSM-application programming interface of the ID wallet (330) and the ID-wallet-to-ID-wallet communication interface (340), wherein the communication interface has a DIDComm interface (341) and an OpenID4VC interface (342), and the two terminals are each connected to one another by means of the ID-wallet-to-ID-wallet communication interface (340), FIG. 6 shows a digital credentials registry (203) having two registry entries (203.1 and 203.n), each having a tag-length-value structure, and each consisting of a first credential registry ID (203.x.1), a counter (203.x.2), a Boolean field (203.x.3), an X9.62 ECDSA signature: r-value of the signature (203.x.4) and an X9.62 ECDSA signature: S-value of the signature (203.x.5) FIG. 7.1 shows a first part of a presentation of a credential anchored in the credential registry (203 (A)) of a party A to a party B with the following sequence (executed as a UML sequence diagram)
1.1 (A) sends a DIDComm invitation and transmits a DID document with its own public key (PUK) therein. Alternatively, (B) can also send the DIDComm invitation. In this case, (B) sends the present proof request after (A) has sent the response to the DIDComm invitation.
1.2 (A) receives the response to the DIDComm invitation together with the present proof request. This contains the DID document of (B) with B's public key and a random value as the salt as an initial vector for generating a session key.
1.3.1 This is instructed to be generated by the application program running on the HSM from (A) by transmitting the parameter own DID of (A) to reference the own DID to be used, DID of (B), PUK of the DID of (B), reference of the cryptography algorithm to be used.
1.3.2 The application running on the HSM of (A) generates the derived key (der) therefrom. The derived key is generated from the private key of the referenced DID of (A), the PUK of the DID of (B), and the first installer key (Installateur.symKey) and keeps it in the session (only DIDs and salt are transmitted). The application running on the HSM confirms the key generation (ack).
1.4 (A) generates the symmetric software key (ssk) for DIDComm message encryption from the transmitted salt
1.5.1 ssk can be encrypted by the application running on the HSM using the derived key (der)→enc(der,ssk)
1.5.2 Receiving the encrypted symmetric software key enc(der, ssk) for each credential to be presented, the following sequence is run through:
1.6.1 sending a request to prove ownership of the credential to the application running on the HSM
   1.6.1.1 loading the credential from the credential registry
   1.6.1.2 receiving the credential from the credential registry
1.6.2 encrypting the credential using the derived key (der)
1.6.3 generating the DIDComm message (PresentProof), and
1.7 transferring enc(der, ssk) to the DIDComm (each message has its own key)
1.8 transferring the presentation,
FIG. 7.2 shows a second part of the verification of the presentation of a credential anchored in the credential registry (203 (A)) of a party A to a party B by the party B, having the following sequence (executed as a UML sequence diagram)
2.1.1 sending the key derivation request for the derived key to the application running on the HSM
2.1.2 deriving the derived key der in the verifier's application running on the HSM. This takes place analogously to step 1.3.2, except that the PUK of DID (A) and the private key of DID (B) are used.
2.2 loading the holder's PUK
2.3 verifying the holder's signature via the presentation.
For each presented credential, the following sequence is run through:
2.4.1 loading the issuer credential chain from the presentation. The issuer credential is referenced by the presented credential and documents the DID and legitimacy of the issuer. Through the structure of the issuer organization and the documentation of key rotations, a plurality of credentials can reference one another sequentially and form a chain.
2.4.2 checking the issuer credential chain:
1. cryptographic consistency of the chain
2. Presence of a DID of the chain in its own memory area for trusted digital credentials—this determines the trustworthiness of the issuer.
2.4.3 Load the issuer's PUK (PUK.issuer) from the issuer credential chain attached to the credential
2.4.4 verifying the signature of the presented credential
   2.4.5.1 extracting the encrypted RegEntry of the credential from the presentation and passing it to the HSM's own application that is running thereon
   2.4.5.2 in the ASM, decrypting the CRE of the credential with der (der, see 2.1.2)
   2.4.5.3 checking the concatenation of the credential with the credential

$$( Hash ( Sig ( Cred ) ) = ID . RegEntry + proof ( PUK . issuer ; Sig ( RegEntry ) ) = true ) ,$$

wherein
1. Sig(RegEntry)=s-value of the signature
2. r-value(random)=salt
3. Counter=max present counter
4. X9.62 ECDSA value of the signature=container of the r- and s-values
   2.4.5.4 evaluating the transmitted Boolean field (203.x.3)
   2.4.5.5 returning the overall test result to the ID wallet (B)
3 response from the ID wallet (B) to the ID wallet (A).

One embodiment of a system according to the invention has six categories of possible, non-copyable verifiable credentials:

| non-copyable | | |
|---|---|---|
| verifiable credential | transferable | not transferable |
| issuer-bound | issuer DID in the header of | issuer DID in the header of |
| | the VC, signature-secured, | the VC, signature-secured, |
| | flag in the registry entry in | flag in the registry entry in |
| | the digital credentials | the digital credentials |
| | registry (203) set to | registry (203) set to “not |
| | “transferable” | transferable” |
| | e.g. non-registered share, | e.g. group access |
| | cash check, digital banknote | authorization to buildings |
| | or concert ticket | |
| holder-bound | holder DID in the header of | holder DID in the header of |
| | the VC, signature-secured, | the VC, signature-secured, |
| | flag in the registry entry in | flag in the registry entry in |
| | the digital credentials | the digital credentials |
| | registry (203) set to | registry (203) set to “not |
| | “transferable” | transferable” |
| | e.g. completed ballot card, | e.g. holder-bound access |
| | issued by the anonymous | token to a safe deposit box |
| | voter at the polling location | |
| issuer + holder- | issuer DID and holder DID in | issuer DID and holder DID |
| bound | the header of the VC, | in the header of the VC, |
| | signature-secured, flag in the | signature-secured, flag in |
| | registry entry in the digital | the registry entry in the |
| | credentials registry (203) set | digital credentials registry |
| | to “transferable” | (203) set to “not transferable” |
| | e.g. driving license or power | e.g. monthly public |
| | of attorney with the right to | transport ticket, delegation |
| | sub-authorization, e.g. | credential or EC tickets |
| | healthcare proxy or | |
| | authorization to pick up child | |
| | from kindergarten | |

One embodiment of a system for the secure exchange of digital credentials between two actors of a common digital ID ecosystem comprises:
a first acs ACOSJ-DI 95K chip card (50)
a first ID wallet (300)
a first Samsung Galaxy A53 smartphone (10), the first acs ACOSJ-DI 95K chip card (50) being connected to the first ID wallet (300) by means of a DIDComm interface 341 via the first Samsung Galaxy A53 smartphone (10),
a first applet (200) stored on the first acs ACOSJ-DI 95K chip card (50) which is designed to establish, control and manage communication between the first acs ACOSJ-DI 95K chip card (50) and the first Samsung Galaxy A53 smartphone, as well as to carry out computing operations on the first acs ACOSJ-DI 95K chip card (50), wherein
the first acs ACOSJ-DI 95K (50) has an installer's key registry (201) for storing four cryptographic keys for symmetrically encrypted communication between the first hardware security module (50) by means of the first ID wallet (300) and at least one second hardware security module (50a) connected to at least one second ID wallet (300) suitable for communication with the first ID wallet (300), transferable information designed keys,
the first hardware security module (50) has an identity key registry (202) for storing a private key,
the first acs ACOSJ-DI 95K chip card (50) has a digital credentials registry (203), the digital credentials registry (203) being suitable for containing digital credential registry entries, the registry entries including designations of digital credentials as well as hash values of these digital credentials, information about an issuer, signatures and statuses of these digital credentials,
the first acs ACOSJ-DI 95K chip card (50) is configured to
   perform cryptographic computing operations,
   generate, store, delete and manage a self-sovereign identity (SSI) and at least one key pair that belongs to the SSI and is suitable for asymmetric encryption by means of the first applet (200), the suitable key pair comprising a private key and a public key,
   to manage a calculated hash value of the SSI public key, defined as a decentralized identifier (DID), in the ID wallet (300),
the first acs ACOSJ-DI 95K (50)
   prevents any transfer of private keys from or into the identity key registry (202) of the first acs ACOSJ-DI 95K (50) and
   allows public keys to be transferred via the ID-wallet-to-ID-wallet communication interface (340).

One embodiment of a method for secure communication between two systems for verifying and transmitting digital credentials, in particular verifiable digital credentials, is characterized in that the first ID wallet (300) is connected to the first hardware acs ACOSJ-DI 95K chip card (50) and the second ID wallet (300a) is connected to the second acs ACOSJ-DI 95K chip card (50), the applet (200) of the first acs ACOSJ-DI 95K (50)
generating and managing at least one cryptographic key, the key being used to encrypt and decrypt, sign and verify at least one verifiable digital credential in the first ID wallet (300)
establishing secure communication by means of asymmetric cryptography, the encryption process being carried out by the first acs ACOSJ-DI 95K chip card (50) and each acs ACOSJ-DI 95K (50) preventing any transfer of private keys from or into the key registry, and
preventing the applet (200) of the first acs ACOSJ-DI 95K chip card (50) from writing content into its own digital credentials registry (203) itself.

### REFERENCE SIGNS

10 Mobile computing unit (phone/smartphone/tablet)
11 Mobile unattended computing unit (Internet of things device)
20 PC mobile computing unit
30 Stationary human-operated computing unit
40 Stationary computing unit for automated data processing
50 First hardware security module (HSM)
50a Second hardware security module (HSM)
60 USB chip card reader
61 USB connection
62 ISO 7816-3 connection
70 Bluetooth chip card reader
71 Bluetooth connection
100 Data transport interface
110 TCP/IP connection
120 Nearby share connection
130 Wi-Fi Direct
140 AirDrop connection
150 Bluetooth
200 First application/applet installed on the first HSM
200a Second application/applet installed on the second HSM
201 Installer's key registry of the first HSM
201a Installer's key registry of the second HSM
202 Identity key registry of the first HSM
202a Identity key registry of the second HSM
203 Digital credentials registry
203.x.1 Credential registry ID
203.x.2 Counter
203.x.3 Boolean field
203.x.4 X9.62 ECDSA signature: r-value of the signature
203.x.5 X9.62 ECDSA Signature: s-value of the signature
210 Application-HSM interface
300 First ID wallet
300a Second ID wallet
310 ID wallet user interface
320 ID wallet business process logic
330 ID-wallet-to-HSM communication interface/ID wallet HSM-application programming interface
340 ID-wallet-to-ID-wallet communication interface
341 DIDComm interface
342 OpenID4VC interface
350 Digital evidence memory area
360 Trusted digital evidence memory area

1. A system for the secure issuance, receipt, presentation and verification of digital credentials between two actors of a common digital ID ecosystem, at least comprising:
at least one first hardware security module (50) which is constructed such that its functions can only be controlled by using an application-HSM interface (210) of a first application (200),
at least one first ID wallet (300) comprising at least one ID-wallet-to-ID-wallet communication interface (340) that is suitable for communication with at least one second ID wallet (300a),
at least one first digital terminal (10) on which the first ID wallet (300) is installed, the first ID wallet (300) being connected to the first hardware security module (50) by means of an ID-wallet-to-HSM communication interface (330) and being designed to communicate with the first application (200) using the application-HSM interface (210),
at least one first application (200) which is stored on the first hardware security module (50) and is designed to establish, control and manage communication between the first hardware security module (50) and the first digital terminal (10), as well as to carry out computing operations on the first hardware security module (50),
wherein
the first hardware security module (50) has at least one installer's key registry (201) for storing at least one cryptographic key that is suitable for symmetrically encrypted communication between the first application (200) stored on the first hardware security module (50) and a second application (200a) stored on a second hardware security module (50a) by means of the first ID wallet (300) and a second ID wallet (300a) equipped with at least the ID-wallet-to-ID-wallet communication interface (340a) that is suitable for communication with the first ID wallet (300),
the first hardware security module (50) has at least one identity key registry (202) for storing at least one private key,
the first hardware security module (50) has at least one digital credentials registry (203), the digital credentials registry (203) being suitable for containing digital credential registry entries, the registry entries including digital credential designations as well as hash values for these digital credentials, information about an issuer, signatures and statuses of these digital credentials,
the first hardware security module (50) is configured to
perform cryptographic computing operations,
generate, store, delete and/or manage, by means of the first application (200), at least one self-sovereign identity (SSI) and at least one key pair belonging to the SSI and suitable for asymmetric encryption, the suitable key pair comprising a private key and a public key,
manage at least one hash value calculated for the public key of the SSI, defined as a decentralized identifier (DID), in the ID wallet (300),
the first hardware security module (50)
prevents any transfer of private keys from or into the identity key registry (202) of the first hardware security module (50), and
allows transfers of public keys via the application-HSM interface (210).

2. The system according to claim 1, characterized in that the first ID wallet (300) has at least one memory which is suitable for containing encrypted digital credentials, keys for encrypting the digital credentials being stored in the hardware security module (50) and the memory having
at least one first memory area (350) for verifiable digital credentials issued to the holder of the first ID wallet (300), and
at least one second memory area (360) for trusted digital credentials and/or chains of credentials issued to actors classified as trustworthy by the holder of the first ID wallet (300), the trusted digital credentials and/or chains of credentials each having at least one first public cryptographic key.

3. The system according to claim 1, characterized in that the first application (200) is designed to generate and/or manage verifiable digital credentials in the memory of the first ID wallet (300), the verifiable digital credentials comprising an assignment to a DID of the issuer.

4. The system according to claim 2, characterized in that the first ID wallet (300) is designed to cryptographically verify and store the integrity of trusted digital credentials which have a public cryptographic key and of which the public cryptographic key is associated with a digital identity cited in the trusted digital credential.

5. The system according to claim 2, characterized in that the verifiable digital credentials each have an issuer DID, and
the first application (200) is configured such that only the application (200a) provided by the second hardware security module (50a) is able to store digital credential registry entries in the digital credentials registry (203) of the first hardware security module (50), these registry entries either coming directly from the issuer and the first application (200) checking whether the entry has been signed by the application (200a) or the registry entries are marked as transferable, and/or
are issued to a DID of the holder of the first ID wallet (300) and the first application (200) is configured to store or delete the hash value for the verifiable digital credential in the digital credentials registry (203), and the registry entries for verifiable digital credentials having at least one status variable, a status of the status variable determining whether each verifiable digital credential can be copied and/or lent and/or transferred by the first ID wallet (300) to the second ID wallet (300a).

6. The system according to claim 1, characterized in that the installer's key registry (201) of the first hardware security module (50) has at least one first non-readable secret symmetric key which is designed to enable the creation of at least one communication key for encrypted communication with the second hardware security module (50a) by means of a symmetric encryption method, the second hardware security module (50a) having an installer's key registry (201a) and the installer's key registry (201a) of the second hardware security module (50a) having the same non-readable secret symmetric key.

7. The system according to claim 1, characterized in that the installer's key registry (201) of the first hardware security module (50) has at least one second non-readable secret symmetric key which is designed to carry out changes by an installer in the installer's key registry (201) of the first hardware security module (50).

8. A method for secure communication between two systems according to claim 1 for the verification and/or transmission of digital credentials, in particular verifiable digital credentials, characterized in that the first ID wallet (300) is connected to the first hardware security module (50) and the second ID wallet (300a) is connected to the second hardware security module (50a), the application (200) of the first hardware security module (50)
generating and/or managing at least one cryptographic key, the key being used to encrypt and/or decrypt and/or sign and/or verify at least one verifiable digital credential in the first ID wallet (300),
establishing secure communication by means of asymmetric cryptography, the encryption process being carried out by the first hardware security module (50) and each hardware security module (50) preventing any transfer of private keys from or into the key registry, and
preventing the application (200) of the first hardware security module (50) from writing content into its own digital credentials registry (203) itself.

9. The method according to claim 8, characterized in that the status of at least one status variable of at least one registry entry in the digital credentials registry (203) of the first hardware security module (50) characterizes the verifiable digital credential associated with this registry entry in the first ID wallet (300) as
being copyable or non-copyable, and/or
being transferable or non-transferable to the second ID wallet (300a), and/or
being lendable or not lendable to the second ID wallet (300a).

10. The method according to claim 8, characterized in that
verifiable digital credentials issued to the holder of the first ID wallet (300) are stored in the first memory area for digital credentials (350), and/or
trustworthy digital credentials and/or chains of credentials issued to actors classified as trustworthy by the holder of the first ID wallet (300) are stored in the second memory area (360) of the first ID wallet (300), the trustworthy digital credentials and/or chains of credentials each having at least the one first public cryptographic key.

11. The method according to claim 8, characterized in that
the first ID wallet (300) and/or the first hardware security module (50) encrypts at least one digital credential with a symmetric software key generated by the first ID wallet (300) on the basis of a random value,
the key thus generated is encrypted by the first ID wallet (300) and/or by the first hardware security module (50), a derived key being generated from
the at least one private key stored in the first identity key registry (202),
the public key of the private key stored in a second identity key registry (202a) located on the second hardware security module (50a),
the at least first non-readable secret symmetric key of the first installer's key registry (201),
the random value,
the first ID wallet (300) and/or the first hardware security module (50) transmits the digital credential that is encrypted with the random value together with the symmetric software key that is encrypted with the derived key to the second ID wallet (300a) and/or to the second to the second hardware security module (50a),
the second ID wallet (300a) extracts the encrypted symmetric software key together with the random value and transmits them to the second hardware security module (50a),
the second ID wallet and/or the second application (200a) generates a symmetric key from
the at least one private key stored in the second identity key registry (202),
the public key of the private key stored in a first identity key registry (202) located on the first hardware security module (50),
the at least first non-readable secret symmetric key of the first installer's key registry (201),
the random value,
the second application (200a) uses the symmetric key thus formed to decrypt the symmetric software key and transmits to the second ID wallet (300a)
the second ID wallet (300a) decrypts the digital credential using the symmetric software key.

12. The method according to claim 8, characterized in that digital credentials are stored in the first memory area (350) and/or in the second memory area (360), which reference one or more other digital credentials stored in the second memory area (360).

13. The method according to claim 8, characterized in that the first hardware security module (50) executes the first application (200) and the first application (200) generates the at least one key pair and/or the pre-rotated key that is suitable for asymmetric encryption and is associated with the at least one DID and stores it in the identity key registry (202) of the first hardware security module (200), the application (200) exporting public cryptographic keys stored on the hardware security module by means of the interface.

14. The method according to claim 8, characterized in that the ID-wallet-HSM communication interface (330) is designed as an HSM-application programming interface (330) and the first ID wallet (300) communicates with the first application (200) by means of the HSM-application programming interface (330), thus enabling data to be exchanged between the first application (200) and the first ID wallet (300).

15. A method for issuing and/or presenting and/or verifying tickets, official documents, tokens, promissory notes and/or digital currency, comprising performing the method according to claim 8.

16. A computer program product which implements a method according to claim 8.

17. The system according to claim 2, characterized in that the first application (200) is designed to generate and/or manage verifiable digital credentials in the memory of the first ID wallet (300), the verifiable digital credentials comprising an assignment to a DID of the issuer.

18. The system according to claim 17, characterized in that the first ID wallet (300) is designed to cryptographically verify and store the integrity of trusted digital credentials which have a public cryptographic key and of which the public cryptographic key is associated with a digital identity cited in the trusted digital credential.

19. The system according to claim 18, characterized in that the verifiable digital credentials each have an issuer DID, and
the first application (200) is configured such that only the application (200a) provided by the second hardware security module (50a) is able to store digital credential registry entries in the digital credentials registry (203) of the first hardware security module (50), these registry entries either coming directly from the issuer and the first application (200) checking whether the entry has been signed by the application (200a) or the registry entries are marked as transferable, and/or
are issued to a DID of the holder of the first ID wallet (300) and the first application (200) is configured to store or delete the hash value for the verifiable digital credential in the digital credentials registry (203), and the registry entries for verifiable digital credentials having at least one status variable, a status of the status variable determining whether each verifiable digital credential can be copied and/or lent and/or transferred by the first ID wallet (300) to the second ID wallet (300a).

20. The system according to claim 19, characterized in that the installer's key registry (201) of the first hardware security module (50) has at least one first non-readable secret symmetric key which is designed to enable the creation of at least one communication key for encrypted communication with the second hardware security module (50a) by means of a symmetric encryption method, the second hardware security module (50a) having an installer's key registry (201a) and the installer's key registry (201a) of the second hardware security module (50a) having the same non-readable secret symmetric key.
